(19) United States
(12) Patent Application Publication
(10) Pub. No.: US 2022/0334912 A1
(43) Pub. Date: Oct. 20, 2022

(54) SYSTEM AND METHOD FOR VISUALIZING RESULTS OF CAUSE DIAGNOSIS OF EVENT THAT HAS OCCURRED OR MAY OCCUR IN EQUIPMENT

(71) Applicant: Hitachi, Ltd., Tokyo (JP)

(72) Inventors: Kana OKI, Tokyo (JP); Shuntaro HITOMI, Tokyo (JP); Kazuyuki OOTA, Tokyo (JP)

(21) Appl. No.: 17/680,836

(22) Filed: Feb. 25, 2022

(30) Foreign Application Priority Data
Apr. 15, 2021 (JP) 2021-069282

(51) Int. Cl. G06F 11/07

(52) U.S. Cl. CPC G06F 11/0769; G06F 11/079; G06F 11/0721

(57) ABSTRACT

A system displays a fault tree of a generated event on the basis of input information including diagnosis result information representing results of diagnosis of the cause of the generated event. The input information includes information representing causal relationships between a plurality of elements, including the generated event, failure causes that may be a cause of the event, and check items associated with the failure causes. The diagnosis result information includes an occurrence probability of each failure cause. The system determines, as highlighting target edges, all edges belonging to a path from a node corresponding to the generated event to a node corresponding to a failure cause having an occurrence probability that satisfies predetermined probability conditions, and all or some edges coupling the node corresponding to the failure cause having an occurrence probability that satisfies the predetermined probability conditions to nodes corresponding to check items associated with the failure cause.

### CROSS-REFERENCE TO PRIOR APPLICATION

This application relates to and claims the benefit of priority from Japanese Patent Application number 2021-69282, filed on Apr. 15, 2021 the entire disclosure of which is incorporated herein by reference.

### BACKGROUND

The present invention generally relates to visualization of results of diagnosis of the cause of an event that has occurred or may occur in equipment.

A fault tree (hereinafter, FT) is known as a tool for supporting diagnosis of the cause of a generated event that has occurred or may occur in equipment. In maintenance work, a subject matter expert (SME) draws an FT and analyzes the cause of a generated event using the drawn FT.

However, the FT is drawn in any desired format of an SME, and knowledge is not always shared between SMEs.

Therefore, it is conceivable to construct a failure knowledge network, which is information representing the causal relationship between a generated event and the cause thereof, for each possible generated event and visualize a failure knowledge network that corresponds to a designated generated event by the method disclosed in Patent Literature 1.

Patent Literature 1: Japanese Patent Application Publication No. 2020-98387

### SUMMARY

Even if the above-described failure knowledge network is visualized by the method disclosed in Patent Literature 1, there are the following problems.
Although there are items to be checked regarding the cause of a generated event in diagnosis of the cause of the generated event, the relationship between the cause of the generated event and the check items cannot be visualized.
An effective graph based on the failure knowledge network cannot show an inference path in diagnosis of the cause of the generated event.

A diagnostic result visualization system includes an input unit configured to receive input information including diagnosis result information representing results of diagnosis of cause of a generated event that is an event that has occurred or may occur with respect to equipment, and a control unit configured to display a tree UI that is a UI having a fault tree of the generated event on the basis of the input information. The input information includes a failure knowledge network that is information representing a causal relationship between a plurality of elements, each of which is a cause or a result. The plurality of elements include the generated event, one or more failure causes that may be a cause of the event, and a plurality of check items associated with the one or more failure causes. The input information includes information representing, for each of the plurality of elements, a layer to which the element belongs. The diagnosis result information includes an occurrence probability that is a value indicating, for each of the one or more failure causes, a likelihood that the failure cause is relevant and is a value calculated in diagnosis of cause. The fault tree is a tree having a plurality of edges coupling nodes and a plurality of nodes corresponding respectively to the plurality of elements. The control unit determines, for each of the plurality of elements, a drawing position of a node corresponding to the element on the basis of a layer to which the element belongs. The control unit determines, as display target edges in a first highlighting mode, all edges belonging to a path from a node corresponding to the generated event to a node corresponding to a failure cause having an occurrence probability that satisfies predetermined probability conditions, and all or some of edges coupling the node corresponding to the failure cause having an occurrence probability that satisfies the predetermined probability conditions to nodes corresponding to check items associated with the failure cause.

It is possible to display an FT that shows the relationship between the cause of a generated event and check items and an inference path in diagnosis of the cause of the generated event.

### BRIEF DESCRIPTION OF THE DRAWINGS

FIG. 1 shows an overview of an embodiment;

FIG. 2 shows a configuration example of a failure cause diagnosis system;

FIG. 3 shows a configuration example of a failure knowledge network in failure knowledge information;

FIG. 4 shows an example of a causal relationship configuration represented by a failure knowledge network;

FIG. 5 shows a configuration example of data other than a failure knowledge network in input information;

FIG. 6 shows a configuration example of visualization information;

FIG. 7 shows a part of a configuration example of management information;

FIG. 8 shows the rest of the configuration example of the management information;

FIG. 9 shows a user interface (UI) provided by a control unit;

FIG. 10 shows an example of a cause diagnosis UI;

FIG. 11 shows an example of an influence degree UI;

FIG. 12 shows an example of a correction history UI;

FIG. 13 shows the overall flow of processing performed in an embodiment;

FIG. 14 shows an example of a tree UI when a node is designated;

FIG. 15 shows a first specific example of FT configuration correction; and

FIG. 16 shows a second specific example of FT configuration correction.

### DESCRIPTION OF EMBODIMENTS

In the following description, an “interface apparatus” may be one or more interface devices. The one or more interface devices may be at least one of the following.
One or more input/output (I/O) interface devices. An input/output (I/O) interface device is an interface device for at least one of an I/O device and a remote display computer. The I/O interface device for the display computer may be a communication interface device. The at least one I/O device may be any of a user interface device, for example, an input device such as a keyboard and a pointing device, and an output device such as a display device.
One or more communication interface devices. One or more communication interface devices may be one or more homogenous communication interface devices (for example, one or more network interface cards (NICs)) or two or more heterogeneous communication interface devices (for example, an NIC and a host bus adapter (HBA)).

Further, in the following description, a “memory” is one or more memory devices, and may be typically a main storage device. At least one memory device in the memory may be a volatile memory device or a non-volatile memory device.

Further, in the following description, a “permanent storage apparatus” is one or more permanent storage devices. A permanent storage device is typically a non-volatile storage device (for example, an auxiliary storage device), and specifically, a hard disk drive (HDD) or a solid state drive (SSD), for example.

Further, in the following description, a “storage apparatus” may be a memory and at least a memory of a permanent storage apparatus.

Further, in the following description, a “processor” is one or more processor devices. At least one processor device is typically a microprocessor device such as a central processing unit (CPU), but may be another type of processor device such as a graphics processing unit (GPU). At least one processor device may be a single core or a multi-core. At least one processor device may be a processor core. At least one processor device may be a processor device in a broad sense such as a hardware circuit (for example, a field-programmable gate array (FPGA) or an application specific integrated circuit (ASIC)) that performs a part or all of processing.

Further, although information that can be output for an input may be described in an expression such as “xxx table” in the following description, the information may be data in any structure or may be a learning model such as a neural network that generates an output for an input. Therefore, the “xxx table” can be referred to as “xxx information.” Further, in the following description, a configuration of each table is an example, and one table may be divided into two or more tables, or all or some of two or more tables may be one table.

Further, although a function may be described in an expression of “kkk unit” in the following description, a function may be realized by a processor executing one or more computer programs or may be realized by one or more hardware circuits (for example, an FPGA or an ASIC). When a function is realized by a processor executing a program, specified processing is appropriately performed using a storage apparatus and/or an interface apparatus, and thus the function may be at least a part of the processor. Processing described with a function as a subject may be processing performed by a processor or an apparatus having the processor. The program may be installed from a program source. The program source may be, for example, a program distribution computer or a computer-readable recording medium (for example, a non-transitory recording medium). Description of each function is an example, and a plurality of functions may be combined into one function, or one function may be divided into a plurality of functions.

Further, in the following description, a common part of reference signs may be used when the same type of elements are not distinguished, and the reference signs may be used when the same type of elements are distinguished.

Further, a “node” and an “edge” are terms in a directed graph. Each of the “node” and the “edge” may be substituted with a different term. For example, the “node” may be referred to as a “vertex.” The “edge” may be referred to as a “link,” a “line,” a “side” or a “branch.”

Hereinafter, an embodiment of the present invention will be described with reference to the drawings. In the following embodiment, an x direction having a +x direction (right direction) and a −x direction (left direction) is a horizontal direction, and a y direction having a +y direction (upward direction) and a −y direction (downward direction) is a vertical direction.

Hereinafter, an embodiment of the present invention will be described. Although it is assumed that both a user who manually inputs information and a user who browses visualized cause diagnosis results are one subject matter expert (SME) in the following description in order to simplify description, a user who manually inputs information and a user who browses cause diagnosis results may be different users. Further, a user is not limited to an SME.

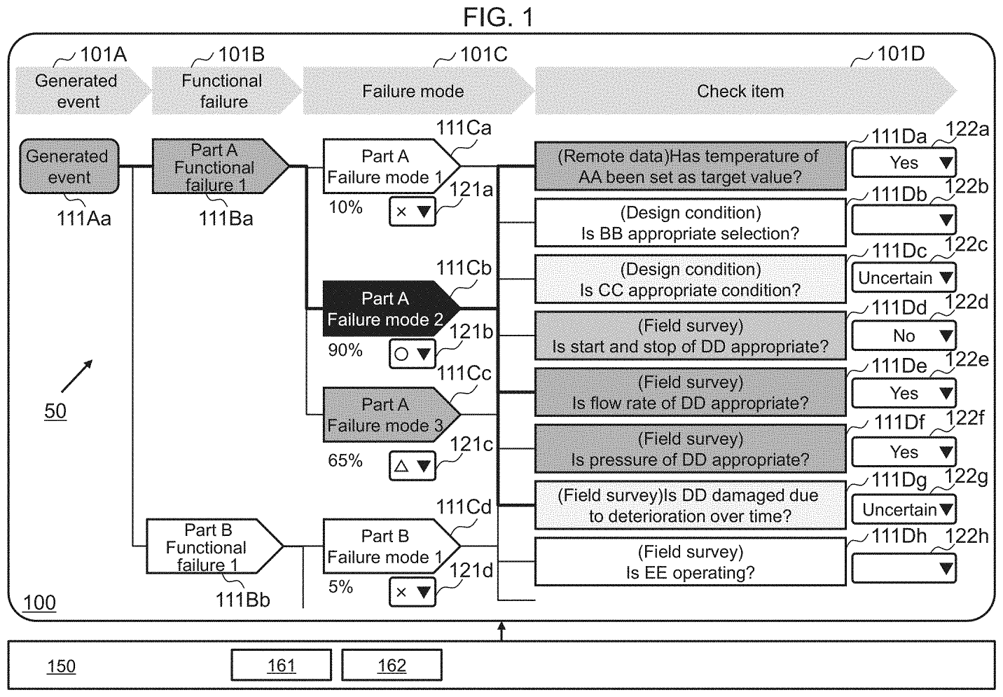

FIG. 1 shows an overview of an embodiment.

A failure cause diagnosis system 150 to which a diagnostic result visualization system is applied includes an input unit 161 that receives input information including diagnosis result information representing results of diagnosis of the cause of a generated event (event that has occurred or may occur with respect to equipment), and a control unit 162 that displays a tree UI 100 on the basis of the input information. The tree UI 100 is a user interface (UI) having a fault tree (FT) 50 of generated events.

The input information includes a failure knowledge network, which is information representing the causal relationship of a plurality of elements which are causes or results. The plurality of elements include a generated event, one or a plurality of functional failures that can be the cause of the generated event (an example of one or a plurality of failure events), and one or more failure modes (an example of one or more failure causes) that can be the cause of a corresponding functional failure for each of the one or a plurality of functional failures. The plurality of elements further includes a plurality of check items associated with one or a plurality of failure modes. Hereinafter, for convenience, a node corresponding to a generated event may be referred to as an “generated event node,” a node corresponding to a functional failure may be referred to as a “functional failure mode,” a node corresponding to a failure mode may be referred to as a “failure mode node,” and a node corresponding to a check item may be referred to as a “check item node.” In the FT 50, every node 111 is a figure. Further, although an arrow is not displayed at the end of any edge in the FT 50, it is a directed side having a direction toward a child node.

The input information includes information representing a layer to which a corresponding element belongs for each of the plurality of elements. Diagnosis result information includes an occurrence probability, which is a value indicating a likelihood that a corresponding failure mode is relevant for each of one or a plurality of failure modes and is a value calculated in diagnosis of the cause of the generated event. The FT 50 has a tree (an example of a directed acyclic graph (DAG)) having a plurality of edges coupling nodes and a plurality of nodes respectively corresponding to the plurality of elements.

The control unit 162 determines a drawing position of a node corresponding to an element on the basis of a layer to which the element belongs for each of the plurality of elements. The control unit 162 determines (a) and (b) below as edges that are display targets in a first highlighting mode.
(a) All edges belonging to a path from a generated event node 111A to a failure mode node 111Cb (a node corresponding to a failure mode with the highest occurrence probability). The “failure mode with the highest occurrence probability” is an example of a failure mode in which the occurrence probability satisfies predetermined conditions. When there are a plurality of failure modes with the highest occurrence probability, all or some (for example, one) of the failure modes may be an example of a “failure mode in which the occurrence probability satisfies predetermined conditions.”
(b) All or some edges that couples the failure mode node 111Cb to a check item node 111D (a node corresponding to a check item associated with the failure mode with the highest occurrence probability) coupled to the failure mode node 111Cb.

According to the present embodiment, it is possible to display the FT 50 in which the relationship between the cause of a generated event and a check item and an inference path in diagnosis of the cause of the generated event are represented. Specifically, it is as follows.
Check items are associated with failure modes, and a failure knowledge network includes the check items associated with the failure modes. Accordingly, the FT 50 having the check item node 111D coupled to the failure mode node 111C can be displayed.
Input information includes the occurrence probability of each failure mode in addition to the failure knowledge network, and the edges of (a) and (b) above are highlighted in the first highlighting mode on the basis thereof. A path composed of the edges highlighted in the first highlighting mode is an inference path in diagnosis of the cause of the generated event. That is, the inference path in diagnosis of the cause of the generated event is displayed on the FT 50. Since the structure of the FT 50 is a tree structure, a plurality of nodes belonging to the same layer do not exist above the functional failure modes and failure mode nodes. In other words, there is one or more child nodes for one parent node, but there is one parent node for one child node. In view of such characteristics of the structure of the FT 50, the path from the failure mode node 111C to the root node 111A in the failure mode in which the occurrence probability satisfies predetermined conditions is a non-branched path. Therefore, highlighting the edges belonging to the path contributes to technical realization of representation of an estimated path on the FT 50.

Diagnosis result information includes information representing, for each pair of a failure mode and a check item associated with the failure mode, an influence degree that is a degree to which the check item affects the failure mode and is a value depending on whether or not the check item is relevant. An edge that is a display target in the first highlighting target is an edge having an influence degree that satisfies predetermined influence degree conditions. Accordingly, an inference path can be represented more accurately. Meanwhile, “an influence degree satisfies predetermined influence degree conditions” means that the influence degree is equal to or greater than a threshold value in the present embodiment. The “threshold value” may be a predetermined threshold value or a threshold value determined on the basis of a plurality of influence degrees corresponding to a plurality of pairs (pairs of failure modes and check items). According to the example shown in FIG. 1, among a plurality of edges coupling the failure mode node 111Cb to a plurality of check item nodes 111D, edges coupling the failure mode node 111Cb to check item nodes 111Da, 111De and 111Dg is an edge that is a display target in the first highlighting mode. The example of display in the first highlighting mode is display in a thick line, but edge attributes such as the color and the line type may be changed instead of or in addition to the display.

The control unit 162 determines all nodes 111Aa, 111Ba and 111Cb belonging to the path from the generated event node 111A to the failure mode node 111Cb as nodes that are highlighting targets. Accordingly, the visibility of the inference path can be improved.

The tree UI 100 illustrated in FIG. 1 will be described in detail, for example, as follows.

The FT 50 is a directed acyclic graph (DAC) in a tree structure. In the FT 50, the generated event node 111Aa is a root node. The functional failure modes 111B are child nodes having the generated event node 111Aa as a parent node.

The failure mode nodes 111C are child nodes having the functional failure modes 111B as parent nodes. The check item nodes 111D are leaf nodes as child nodes having the failure mode nodes 111C as parent nodes. Further, the following definitions are adopted in the following description.
Upper nodes of node X: All nodes directly or indirectly coupled to node X and on the side of a root node 111A of node X, which include the parent node of node X.
Lower nodes of node X: All nodes directly or indirectly coupled to node X and on the side of a leaf node 111D of node X, which include child nodes of node X.
Node directly coupled to node X: a parent node or a child node of node X.
Node indirectly coupled to node X: A node coupled to node X via one or more nodes and above the parent node of node X, or a node coupled to node X via one or more nodes and below a child node of node X.
Edge directly coupled to node X: An edge having node X as a coupling source or a coupling destination.
Edge indirectly coupled to node X: An edge coupled to node X via one or more upper nodes of node X, or an edge coupled to node X via one or more lower nodes of node X.

Further, in the present embodiment, “highlighting” of the “highlighting” may be relative. For example, in the FT 50, the display intensity of edges (or nodes) other than edges (or nodes) that are highlighting targets is decreased, and thus relative highlighting of the edges (or nodes) that are highlighting targets may be realized.

A plurality of band-shaped areas corresponding to a plurality of layers are arranged in the x direction (an example of a first direction). The name of a layer and the width of a band-shaped area are represented by a layer object 101 (display object of the layer) corresponding to the layer. Specifically, the layer object 101 is a figure having the text of the name of the layer and the same width as the width of the band-shaped area (long width in the x direction). The band-shaped area is an area in which the length in the y direction (an example of a second direction) is greater than the length in the x direction. For each of the plurality of layers, a drawing position of each of one or more nodes corresponding to one or more elements belonging to a corresponding layer is a position of a band-shaped area corresponding to the layer. Accordingly, an SME can easily understand the relationship between elements and layers. According to the example shown in FIG. 1, four layer objects 101A to 101D corresponding to four layers are arranged in the x direction. A layer on the side of the +x direction is a lower layer.

As a highlighting mode, one or a plurality of types of modes are adopted. For example, it is as follows. Attributes of highlighting, such as color, pattern, line type, and line thickness, may be changed.
First node highlighting is applied to the failure mode node 111Cb (or a node 111 selected by an SME). The first node highlighting is highlighting with highest intensity among display modes of the plurality of nodes 111. The first node highlighting may be applied to failure modes with occurrence probabilities equal to or higher than a first probability instead of or in addition to a failure mode with the highest occurrence probability.
Second node highlighting is applied to nodes directly or indirectly coupled to nodes 111 to which the first node highlighting is applied among nodes 111 other than the check item nodes 111D. The second node highlighting is highlighting having a lower intensity than the first node highlighting.
Second or third node highlighting is applied to nodes 111C corresponding to failure modes having occurrence probabilities equal to or higher than a second probability (for example, failure modes having highest N-th occurrence probabilities) among failure mode nodes 111C to which the first node highlighting is not applied. The third node highlighting is highlighting with a lower intensity than the first node highlighting. Further, the second probability is lower than the first probability.

For each failure mode node 111C, an occurrence probability and a certainty factor UI part 121 are displayed. The occurrence probability is an occurrence probability calculated in diagnosis of cause for the failure mode corresponding to the node 111C. Representation of the occurrence probability is not limited to “%” illustrated in FIG. 1 and, for example, the occurrence probability may be represented in N stages (N is an integer of 2 or more). The certainty factor UI part is a UI part that receives an input of a certainty factor at which an SME determines that a failure mode is the cause of a generated event (specifically, the cause of a functional failure corresponding to a functional failure mode 111B which is the parent node of the failure mode node 111C). According to the example shown in FIG. 1, certainty factor UI parts 121a to 121d corresponding to failure mode nodes 111Ca to 111Cd are displayed. A determination result of the SME can be input for each failure mode. For each failure mode, the “certainty factor” is certainty that the failure mode is the cause and is a determination result of the SME. As illustrated in FIG. 1, the certainty factor may be represented by symbols such as o, x, and A or may be represented by M stages (M is an integer of 2 or more).

Input information input to the input unit 161 includes information representing whether or not a corresponding check item is relevant for each of the plurality of check items. The control unit 162 determines, among the plurality of check item nodes 111Da to 111Dh corresponding to the plurality of check items, nodes 111Da, 111De and 111Df corresponding to relevant check items as check item nodes 111D that are highlight targets. In other words, edges directly coupled to the check item nodes 111D are highlighted when the first node highlighting is applied to the parent nodes 111C to which the edges are coupled and influence degrees on failure modes represented by the parent nodes 111C are high, and whether or not the check item nodes 111D themselves are highlighting targets depends on whether or not the check items corresponding to the nodes 111D are relevant instead of whether or not the first node highlighting is applied to the parent nodes 111C. Accordingly, the SME can check the relationship between the check items corresponding to the child nodes 111D of the failure mode node 111Cb to which the first node highlighting is applied and the check items. As an example of the case where the check items are not relevant, there are “non-relevant,” “uncertain,” and “non-input”, and the display mode of the check item nodes 111D may be different depending on situations of “non-relevant,” “uncertain,” and “non-input.”

Hereinafter, the present embodiment will be described in detail. In the following description, a node “AAA” means a node having a node ID or a name of “AAA.”

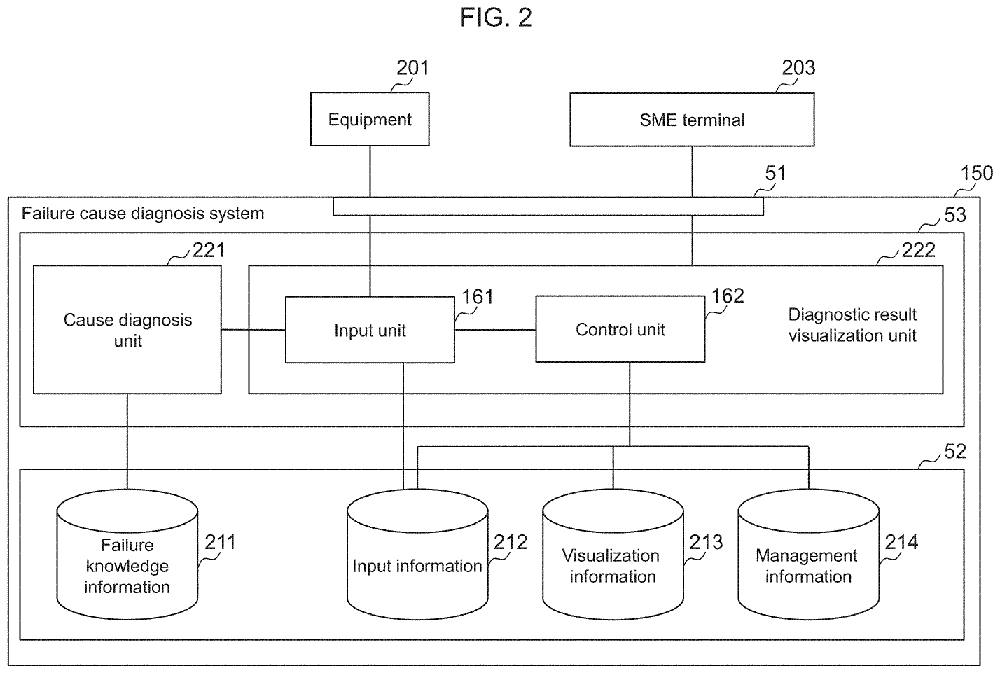

FIG. 2 shows a configuration example of the failure cause diagnosis system 150.

The failure cause diagnosis system 150 is a system to which both a diagnosis system that performs diagnosis of the cause of a generated event and a diagnostic result visualization system that visualizes results of diagnosis of cause are applied. Diagnosis of cause is performed by the cause diagnosis unit 221, and visualization of results of diagnosis of cause is performed by the diagnosis result visualization unit (hereinafter, a visualization unit) 222. The failure cause diagnosis system 150 is a physical system composed of one or more physical computers in the present embodiment, but instead it, may be a logical system provided on the basis of one or more physical computers (for example, the structure of cloud computing). For example, when a computer has a display device and the computer displays information on its own display device, the computer may be the failure cause diagnosis system 150. Further, when a first computer (for example, a server) transmits output information to a remote second computer (a display computer (for example, a client)) and the display computer displays the information (when the first computer displays information on the second computer), for example, at least the first computer between the first computer and the second computer may be the failure cause diagnosis system 150. That is, “displaying output information” by the failure cause diagnosis system 150 may be displaying the output information on a display device of a computer or transmitting the output information by the computer to a display computer (in the latter case, the output information is displayed by the display computer). Further, a diagnostic system and the diagnostic result visualization system may be separated, for example, via a network. For example, the diagnostic system and the diagnostic result visualization system may be the above-mentioned physical systems or logical systems.

The failure cause diagnosis system 150 includes an interface apparatus 51, a storage apparatus 52, and a processor 53 connected thereto.

Equipment 201 (or a storage apparatus in which equipment operation information that is information representing operation details of the equipment 201 is stored) and an SME terminal 203 are coupled to the interface apparatus 51, for example, through a network (for example, a local area network (LAN) or a wide area network (WAN)). The SME terminal 203 is an information processing terminal (for example, a personal computer such as a mobile type or a tablet type, or a smartphone) used by an SME and corresponds to an input/output console.

The storage apparatus 52 stores computer programs and information. The information includes, for example, failure knowledge information 211, input information 212, visualization information 213, and management information 214. The failure knowledge information 211 includes a failure knowledge network and metadata of the failure knowledge network.

The processor 53 realizes a cause diagnosis unit 221 and a visualization unit 222 by executing the computer programs stored in the storage apparatus 52.

The cause diagnosis unit 221 receives information representing designation of a generated event and relevance of each check item from the visualization unit 222. The cause diagnosis unit 221 performs diagnosis of the cause of the designated generated event on the basis of the received information (information representing the relevancy of each check item) and the failure knowledge information 211. The cause diagnosis unit 221 transmits input information including the failure knowledge network and diagnosis result information (information representing results of diagnosis of cause) to the visualization unit 222.

The visualization unit 222 includes an input unit 161 and a control unit 162.

The input unit 161 identifies a generated event from the equipment operation information of the equipment 201. The input unit 161 designates the identified generated event to the cause diagnosis unit 221. The input unit 161 receives the input information 212 including the diagnosis result information of the designated generated event from the cause diagnosis unit 221 and stores the input information 212 in the storage apparatus 52.

The control unit 162 generates the visualization information 213 that is information used for visualization on the basis of the input information 212 and displays the tree UI 100 (and other UIs) on the basis of the visualization information 213. Further, the control unit 162 receives correction via the tree UI 100 (or another UI) and includes information representing details of the correction in the management information 214.

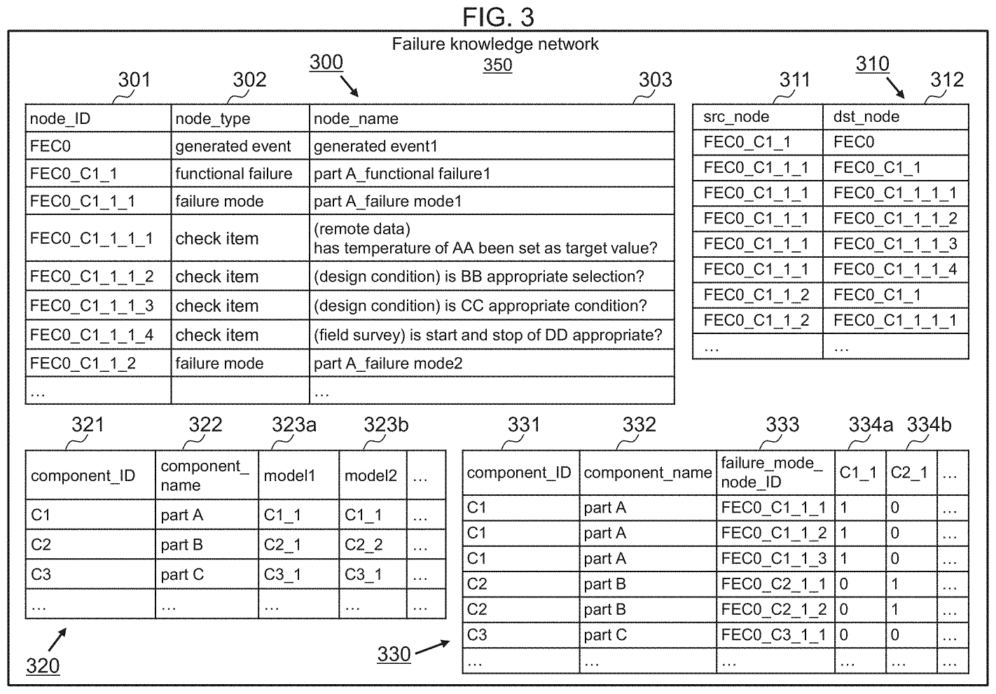

FIG. 3 shows a configuration example of the failure knowledge network in the failure knowledge information 211.

The failure knowledge network 350 includes a node table 300, a node coupling table 310, a part table 320, and a failure mode table 330. Since failure modes that can occur differ depending on models (difference in parts used), the tables 320 and 330 are used in cases where the cause diagnosis unit 221 performs diagnosis of cause in consideration of the model.

The node table 300 has an entry for each node in the failure knowledge network 350, and each entry has information such as node_ID 301, node_type 302, and node_name 303. One node (“target node” in description of FIG. 3) is exemplified.

The node_ID 301 represents the ID of the target node. In the present embodiment, a node ID naming rule (configuration) is event ID_part ID_functional failure ID_failure mode ID_check item ID. Specifically, a node ID composed of only an event ID means a generated event node, a node ID composed of event ID_part ID_functional failure ID means a functional failure mode, a node ID composed of event ID_part ID_functional failure ID_failure mode ID means a failure mode node, and a node ID composed of event ID_part ID_functional failure ID_failure mode ID_check item ID means a check item node. The configuration of event ID_part ID_function failure ID_failure mode ID_check item ID uniquely indicates which element is the cause or result of which element.

The node_type 302 represents the name of the type of the target node. The node_name 303 represents the name of the target node.

The node coupling table 310 has an entry for each edge, and each entry has information such as src_node 311 and dst_node 312. One edge (“target edge” in description of FIG. 3) is exemplified.

The src_node 311 represents the ID of a coupling source node of the target edge. The dst_node 312 represents the ID of a coupling destination node of the target edge.

The part table 320 shows the relationship between an equipment model and a model number of an equipment part. The part table 320 has an entry for each equipment part, and each entry has information such as component_ID 321, component_name 322, and models 323a, 323b, . . One equipment part (“target equipment part” in explanation of FIG. 3) is exemplified.

The component_ID 321 represents the ID of a target equipment part. The component_name 322 represents the name of the target equipment part. When the model 323a among models 323a, 323b, . . . is exemplified, the model 323a represents the model number of the target equipment part. For example, when it is assumed that a part A is a heat exchanger, the first entry in the table 320 illustrated in FIG. 3 means that a heat exchanger having a model number C1_1 is used for equipment of model 1, and a heat exchanger having a model number C1_2 is used for equipment of model 2.

The failure mode table 330 shows the relationship between a part of each model number and a failure mode. The failure mode table 330 has an entry for each failure mode, and each entry has information such as component_ID 331, component_name 332, failure_mode_node_ID 333, and model numbers 334a, 334b, . . . One failure mode (“target failure mode” in description of FIG. 3) is exemplified.

The component_ID 331 represents the ID of an equipment part in which the target failure mode occurs. The component_name 332 represents the name of the equipment part in which the target failure mode occurs. The failure_mode_node_ID 333 represents the model number of the part of the component_name 332. When the model number 334a among the model numbers 334a, 334b, . . . is exemplified, the model number 334a indicates whether or not each failure mode occurs in the model number 334a.

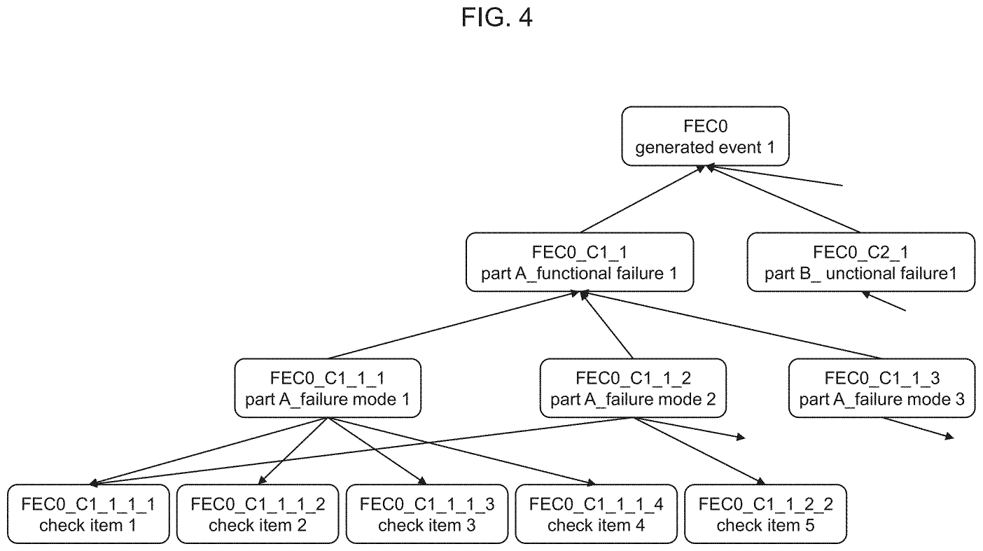

FIG. 4 shows an example of a causal relationship configuration represented by the failure knowledge network 350.

The failure knowledge network 350 is prepared for each generated event. A plurality of elements in the failure knowledge network 350 are generated events, functional failures, failure modes, and check items.

In the failure knowledge network 350, the direction of an arrow means the direction from a cause to a result. Therefore, according to the failure knowledge network 350, a functional failure occurs as a result caused by a failure mode, and a generated event occurs as a result caused by the functional failure. Further, according to the failure knowledge network 350, checking according to a check item occurs as a result caused by the failure mode.

Although a check item is associated with a failure mode in the failure knowledge network 350 according to the present embodiment, it is assumed that two different types of results (functional failure and check items) occur caused by one failure mode because the direction from a cause to a result is adopted due to the configuration of the failure knowledge network 350. Therefore, in the failure knowledge network 350, the relationship between elements (relationship between nodes) is generated event←functional failure←failure mode→check item, as illustrated. Accordingly, a tree structure with a common edge direction cannot be displayed through mere visualization of the failure knowledge network 350.

Therefore, in the present embodiment, the control unit 162 reverses the relationship between a generated event and a functional failure (switch a cause and a result) and reverses the relationship between a functional failure and a failure mode, as will be described later. Accordingly, the relationship between elements becomes generated event→functional failure→failure mode→check item. That is, a base that displays a tree structure with a common edge direction is constructed.

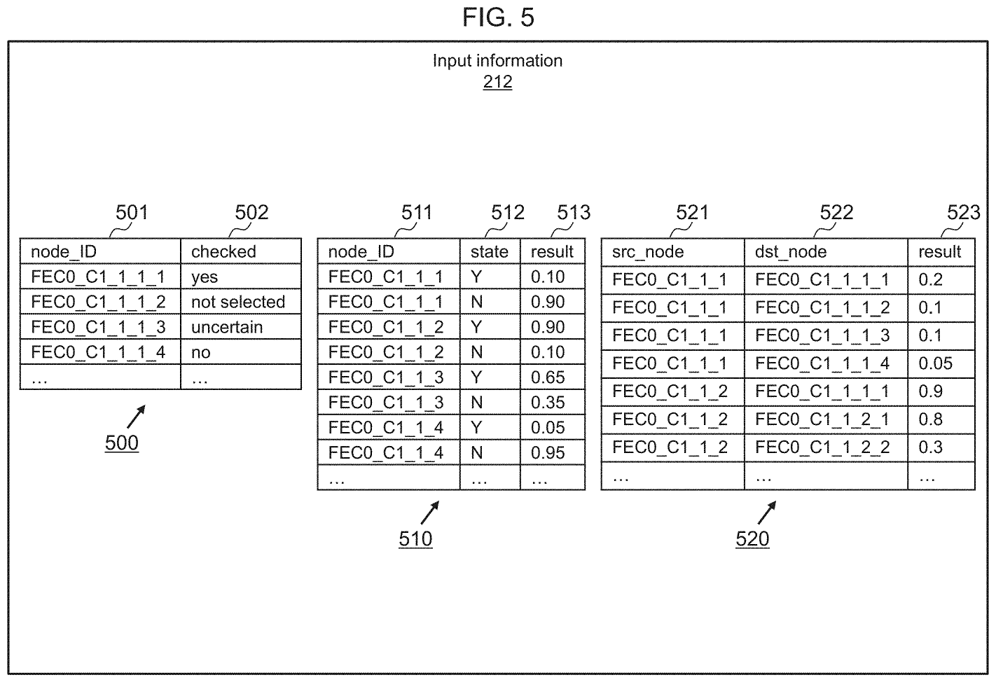

FIG. 5 shows a configuration example of data other than the failure knowledge network 350 in the input information 212.

The input information 212 includes a check item table 500, an occurrence probability table 510, and an influence degree table 520 in addition to the failure knowledge network 350.

The check item table 500 has an entry for each check item, and each entry has information such as node_ID 501 and checked 502. One check item (“target check item” in description of FIG. 5) is exemplified.

The node_ID 501 represents the ID of a check item node of the target check item. The checked 502 represents a value indicating the relevancy of the target check item (for example, “relevant”, “non-relevant”, “not-selected”, and “uncertain”).

The occurrence probability table 510 has an entry for each failure mode, and each entry has information such as node_ID 511, state 512, and result 513. One failure mode (“target failure mode” in description of FIG. 5) is exemplified.

Node_ID 511 represents the ID of a failure mode node of the target failure mode. The state 512 represents whether or not the target failure mode occurs. The result 513 represents the probability that the target failure mode occurs (occurrence probability) or the probability that the target failure mode does not occur. The probability that the target failure mode does not occur substantially means the occurrence probability of the target failure mode. This is because the sum of the occurrence probability of the target failure mode and the probability that the target failure mode does not occur is a constant value (for example, “1”).

The influence degree table 520 has an entry for each pair of a failure mode and a check item, and each entry has information such as src_node 521, dst_node 522, and result 523. One pair (“target pair” in description of FIG. 5) is exemplified.

The src_node 521 represents the ID of a failure mode node of the failure mode in the target pair. The dst_node 522 represents the ID of a check item node of the check item in the target pair. The result 523 represents an influence degree calculated in diagnosis of cause for the target pair.

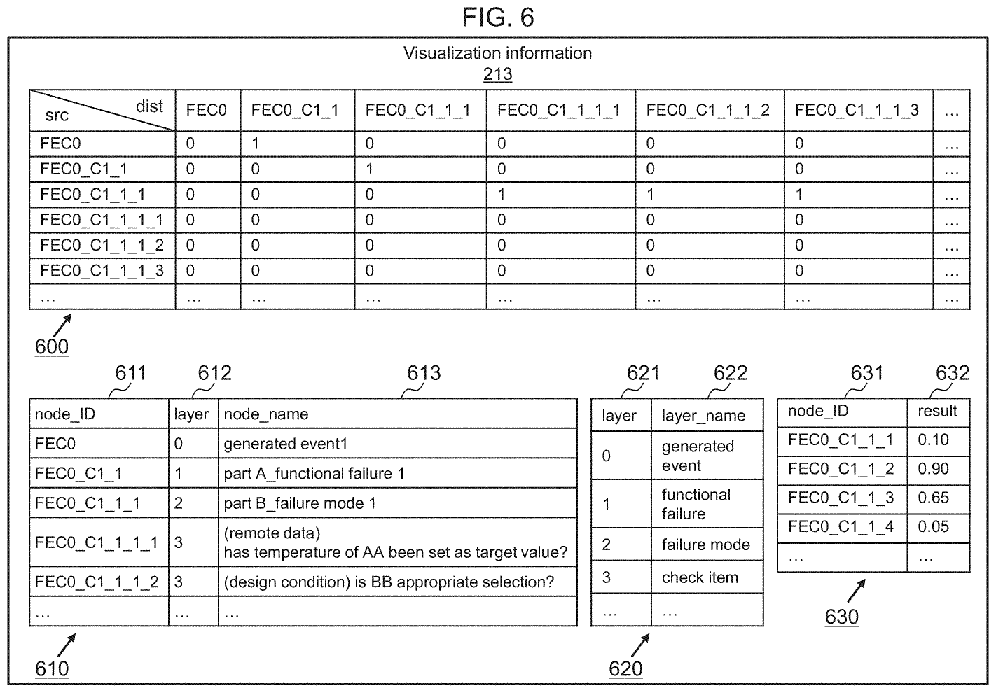

FIG. 6 shows a configuration example of the visualization information 213.

The visualization information 213 includes an FT node coupling table 600, an FT node table 610, a layer table 620, and an FT occurrence probability table 630.

The FT node coupling table 600 shows nodes directly coupled to each other and a direction of an edge at which the nodes are connected in the FT. Specifically, the FT node coupling table 600 represents a node that is a coupling destination (dist) when each node is a coupling source (src). “1” means coupling and “0” means non-coupling. According to the example shown in FIG. 6, there is a child node (coupling destination node) “FEC0_C1_1” having a node “FEC0” as a parent node (coupling source node).

The FT node table 610 has an entry for each node in the FT, and each entry has information such as node_ID 611, layer 612, and node_name 613. One node (“target node” in description of FIG. 6) is exemplified.

The node_ID 611 represents the ID of the target node. The layer 612 represents the number of the layer to which the target node belongs. The node_name 613 represents the name of the target node.

The layer table 620 has an entry for each layer, and each entry has information such as layer 621 and layer_name 622. One layer (“target layer” in description of FIG. 6) is exemplified.

The layer 621 represents the number of the target layer. The layer_name 622 represents the name of the target layer. As a name of a layer, a name of an element type, that is, “generated event,” “functional failure,” “failure mode,” and “check item” can be adopted, as shown in FIG. 6. The layer table 620 may be set in advance by an SME.

The FT occurrence probability table 630 has an entry for each failure mode, and each entry has information such as node_ID 631 and result 632. One failure mode (“target failure mode” in description of FIG. 6) is exemplified.

The node_ID 631 represents the ID of a failure mode node of the target failure mode. The result 632 represents the occurrence probability of the target failure mode.

The visualization information 213 may include an FT influence degree table (for example, a table obtained on the basis of the influence degree table 520 in the input information 212), which is a table showing an influence degree for each pair of a failure mode and a check item. Further, the visualization information 213 may include an FT check item table (for example, a table obtained on the basis of the check item table 500 in the input information 212) which is a table showing relevance of each check item. The display of the FT may be performed on the basis of the FT influence degree table and/or the FT check item table.

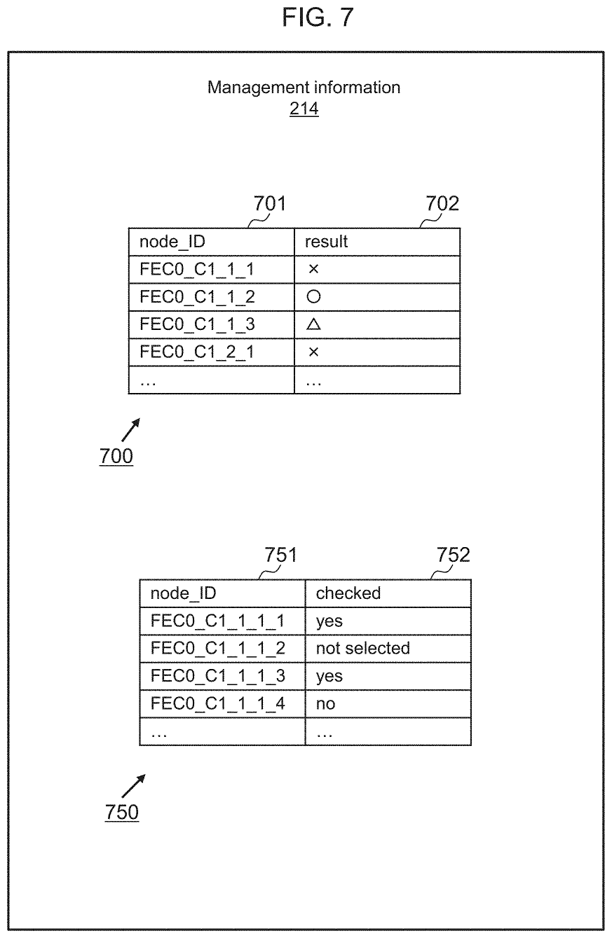

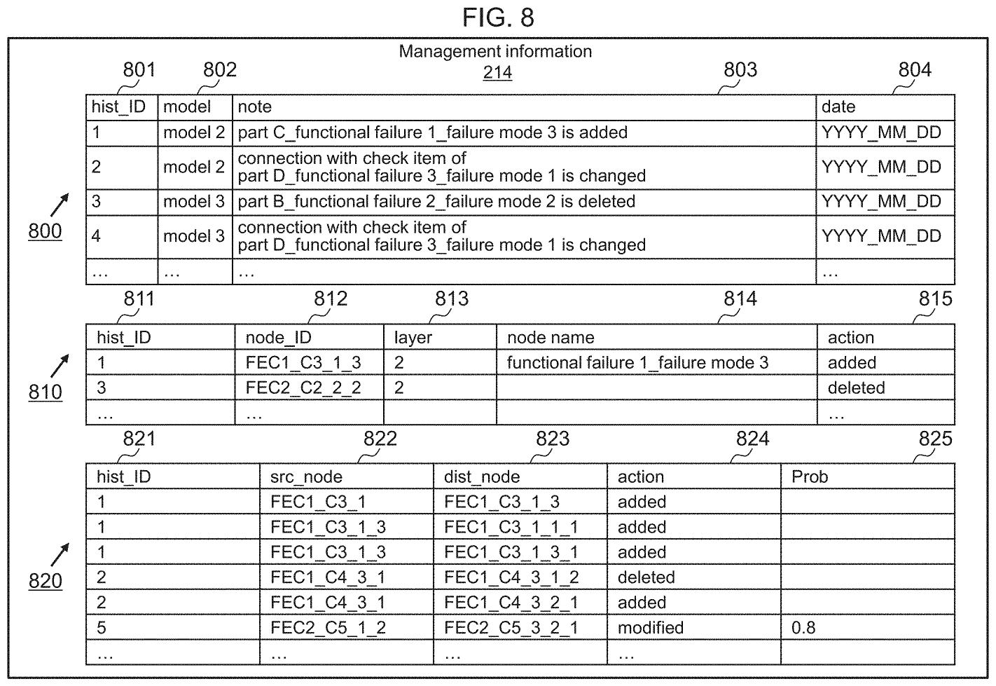

FIG. 7 and FIG. 8 show a configuration example of the management information 214.

The management information 214 includes a certainty factor table 700, a relevance table 750, an FT correction history table 800, a node correction history table 810, and an edge correction history table 820.

The certainty factor table 700 has an entry for each failure mode, and each entry has information such as node_ID 701 and result 702. One failure mode (“target failure mode” in description of FIG. 7) is exemplified.

The node_ID 701 represents the ID of a failure mode node of the target failure mode. The result 702 represents a certainty factor of the target failure mode (a certainty factor input by an SME). As will be described later, the certainty factor table 700 is also used for display control of both a cause diagnosis UI and a tree UI.

The relevance table 750 has an entry for each check item, and each entry has information such as node_ID 751 and checked 752. One check item (“target check item” in explanation of FIG. 7) is exemplified.

The node_ID 751 represents the ID of a check item node of the target check item. The checked 752 represents a value indicating the relevance of the target check item (for example, “relevant”, “non-relevant”, “not-selected”, and “uncertain”). When the relevance of the target check item is changed by an SME, the changed value is recorded as the checked 752. According to the examples of FIG. 5 and FIG. 7, the relevance of a node “FEC0_C1_1_1_3” has been changed from “uncertain” to “relevant.”

The FT correction history table 800 shows a history of corrections of the configuration of the FT 50. The FT correction history table 800 has an entry for each correction, and each entry has information such as hist_ID 801, model 802, note 803, and date 804. Hereinafter, one correction (“target correction” in description of FIG. 8) will be exemplified.

The hist_ID801 represents the number of the target correction. The model 802 represents the name of the model of equipment corresponding to the FT in which target correction has been performed. The note 803 represents details of the target correction (what kind of correction has been performed for which node in the FT). The date 804 represents a time when the target correction has been performed. According to FIG. 8, the unit of time is year, month, and date, but it may be a coarser or finer unit.

The node correction history table 810 shows a history of node corrections. The node correction history table 810 has an entry for each node correction, and each entry has information such as hist_ID 811, node_ID 812, layer 813, a node name 814, and action 815. Hereinafter, one node correction (“target node correction” in description of FIG. 8) will be exemplified.

The hist_ID811 represents the number of correction (correction number recorded in the FT correction history table 800) including the target node correction. The node_ID 812 represents the ID of the node subjected to the target node correction. The layer 813 represents the number of the layer to which the node subjected to the target node correction belongs. The node name 814 represents the name of the node subjected to the target node correction. The action 815 represents details of the target node correction (for example, node addition (“Added”) or node deletion (“Deleted”)).

The edge correction history table 820 represents a history of edge corrections. The edge correction history table 820 has an entry for each edge correction, and each entry has information such as hist_ID 821, src_node 822, dist_node 823, action 824, and Prob 825. Hereinafter, one edge correction (“target edge correction” in description of FIG. 8) will be exemplified.

The hist_ID821 represents the number of correction (correction number recorded in the FT correction history table 800) including the target edge correction. The src_node 822 represents the ID of a coupling source node of an edge subjected to the target edge correction. The dist_node 823 represents the ID of a coupling destination node of the edge subjected to the target edge correction. The action 824 represents details of the target edge correction (for example, edge addition (“Added”) or edge deletion (“Deleted”)). The Prob 825 represents an influence degree with respect to pairs of failure modes and check items after change.

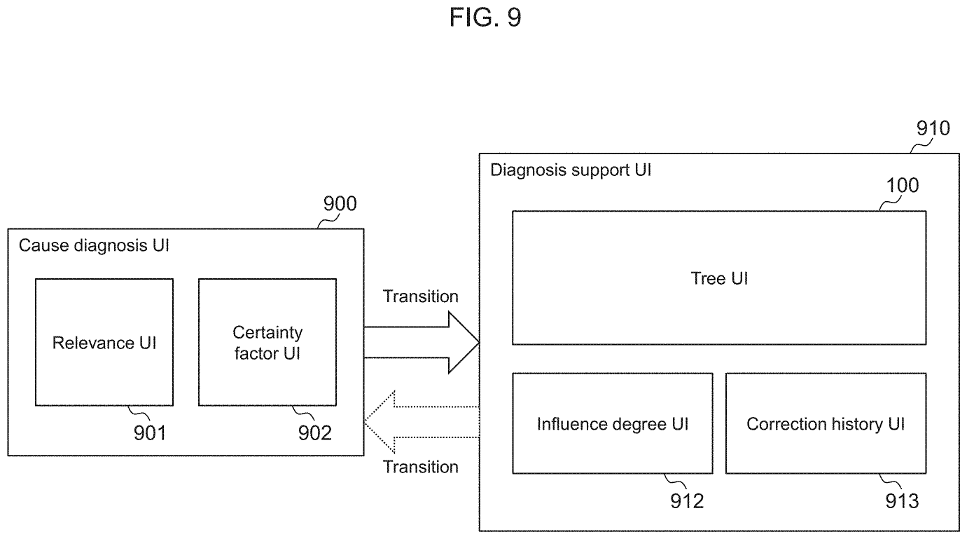

FIG. 9 shows UIs provided by the control unit 162.

UIs provided by the control unit 162 include a cause diagnosis UI 900 and a diagnosis support UI 910.

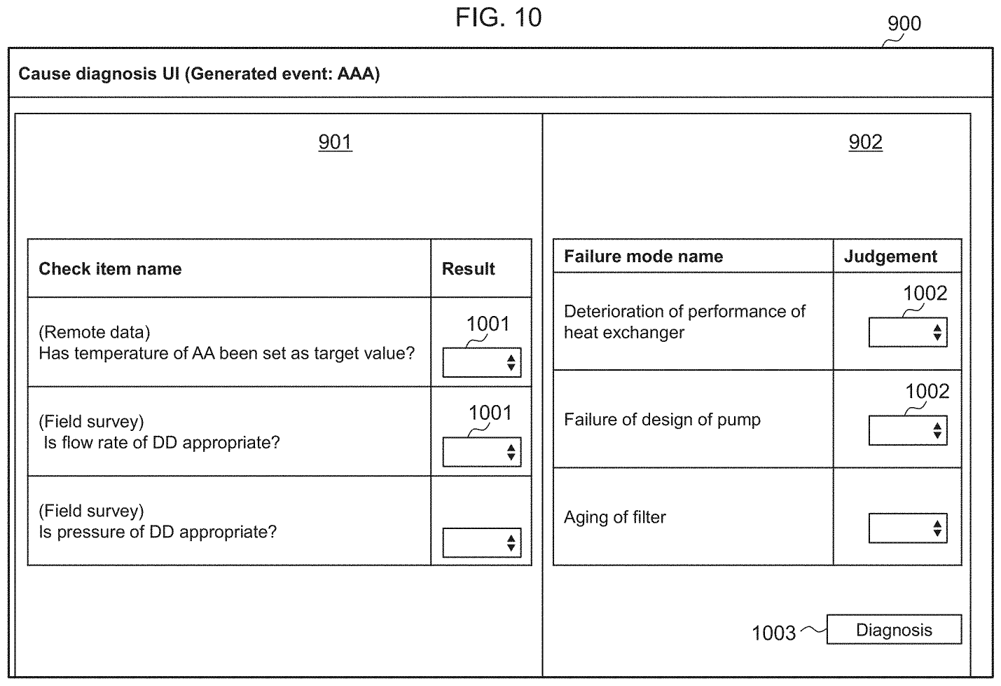

The cause diagnosis UI 900 is, for example, a UI that is displayed before a generated event is identified and diagnosis of cause is started. The cause diagnosis UI 900 includes a relevance UI 901 and a certainty factor UI 902. The cause diagnosis UI 900 is, for example, as shown in FIG. 10. That is, the relevance UI 901 is a UI that displays a check item list (a list of check item names). The relevance UI 901 has a relevance UI part 1001 which is a UI part that receives input of relevance (“relevant”, “non-relevant”, or the like) for each check item. The certainty factor UI 902 is a UI that displays a failure mode list (a list of failure mode names). The certainty factor UI 902 has a certainty factor UI part 1002 which is a UI part that receives input of a certainty factor for each failure mode.

For example, when a cause diagnosis instruction is issued from an SME for the cause diagnosis UI 900 (when a diagnosis button 1003 is pressed), transition of displayed UIs from the cause diagnosis UI 900 to the diagnosis support UI 910 is performed.

The diagnosis support UI 910 includes an influence degree UI 912 and a correction history UI 913 in addition to the tree UI 100 illustrated in FIG. 1.

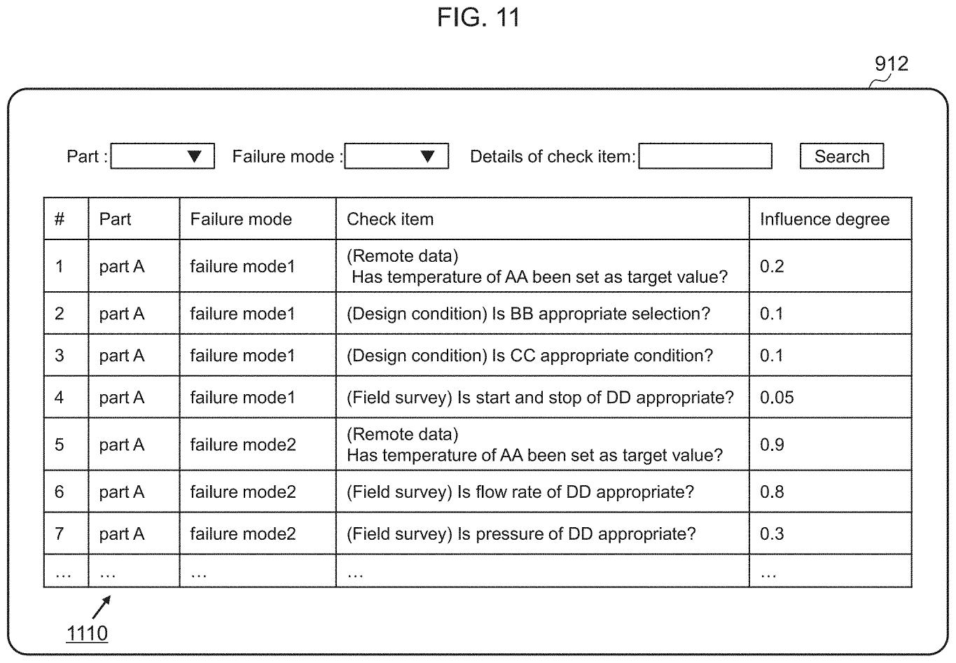

The influence degree UI 912 displays an influence degree list 1110 (an influence degree for each pair of a failure mode and a check item), for example, as shown in FIG. 11. The influence degree list 1110 is displayed on the basis of the influence degree table 520 in the input information 212.

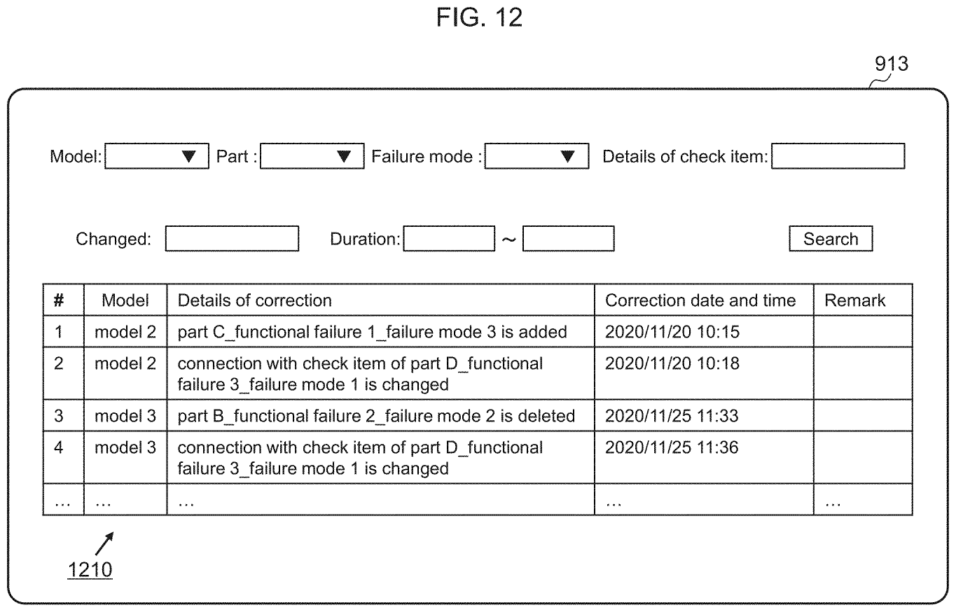

The correction history UI 913 displays a correction list 1210 (a list of information regarding performed corrections), for example, as shown in FIG. 12. The correction list 1210 is displayed on the basis of the FT correction history table 800, the node correction history table 810, and the edge correction history table 820 in the management information 214. An SME can identify details of correction of the same model from the correction list 1210 using the name of the model of the equipment in which a generated event has occurred as a key and can determine correction to be performed on the tree UI 100 on the basis of the identified details of correction.

In the tree UI 100 of the diagnosis support UI 910 after display transition from the cause diagnosis UI 900, a certainty factor input to the cause diagnosis UI 900 with respect to a failure mode is displayed on the certainty factor UI part 121 of the failure mode, and a relevance input to the cause diagnosis UI 900 with respect to a check item is displayed on the relevance UI part 122 of the check item. That is, a determination result of an SME is shared between the cause diagnosis UI 900 and the tree UI 100. Accordingly, the SME can determine the accuracy of the determination result of the SME input to the cause diagnosis UI 900 on the basis of the tree UI 100. Specifically, the following determination is possible, for example.
The SME can determine whether or not a certainty factor input to the cause diagnosis UI 900 is correct on the basis of comparison between a certainty factor and occurrence probability displayed in the vicinity of a failure mode node 111C.
The SME can determine whether or not a relevance input to the cause diagnosis UI 900 is correct on the basis of comparison between a check item coupled to an edge highlighted in the first highlighting target (the edge indicated by a thick line in FIG. 1) and a relevance input with respect to the check item.

Further, since the tree UI 100 has at least one of the certainty factor UI part 121 and the relevance UI part 122 as a UI part that receives input of determination of the SME, a determination result of the SME can be associated with a result of diagnosis of cause from the cause diagnosis unit 221, and thus the result of diagnosis of cause from the cause diagnosis unit 221 can be compared with the determination result of the SME.

Meanwhile, display transition from the diagnosis support UI 910 to the cause diagnosis UI 900 may be performed. Display of the cause diagnosis UI 900 after display transition may reflect details (certainty factors of failure modes and/or relevance of check items) input to the tree UI 100 in the diagnosis support UI 910.

Hereinafter, an example of processing performed in the present embodiment will be described.

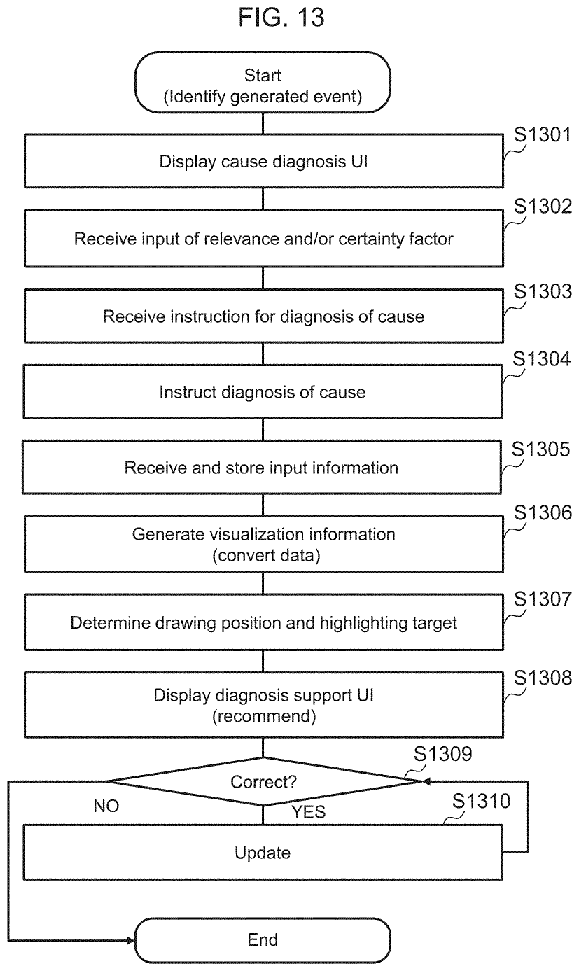

FIG. 13 shows an overall flow of processing performed in the embodiment.

Processing is started when the input unit 161 identifies a generated event from equipment operation information of the equipment 201.

In S1301, the cause diagnosis UI 900 is displayed. Specifically, for example, the input unit 161 notifies the control unit 162 of the identified generated event. The management information 214 may include, for example, a check item list which is a list of check item names and a failure mode list which is a list of failure mode names for each generated event. The control unit 162 identifies a check item list and a failure mode list corresponding to the notified generated event from the management information 214 and displays the cause diagnosis UI 900 displaying the identified lists on the SME terminal 203. Instead of identifying the check item list and the failure mode list from the management information 214, the control unit 162 may inquire of the cause diagnosis unit 221 about check items and failure modes, the cause diagnosis unit 221 may create a check item list and a failure mode list on the basis of information of the failure knowledge information 211 in response to the inquiry, and the control unit 162 may receive the check item list and the failure mode list from the cause diagnosis unit 221 as a response to the inquiry.

In S1302, the control unit 162 receives input of relevance of check items and/or certainty factors of failure modes via the cause diagnosis UI 900.

In S1303, the control unit 162 receives a cause diagnosis instruction (the diagnosis button 1003 is pressed) via the cause diagnosis UI 900.

In S1304, the cause diagnosis instruction is performed on the cause diagnosis unit 221. Specifically, the control unit 162 notifies the input unit 161 of the cause diagnosis instruction, for example. In such a case, the control unit 162 may register information (information representing relevance of each check item and/or a certainty factor of each failure mode) input to the cause diagnosis UI 900 in the management information 214 or associate the information with a notification to the input unit 161. When the input unit 161 receives the notification of the cause diagnosis instruction, the input unit 161 sends a cause diagnosis instruction associated with the aforementioned identified generated event (and the information input to the cause diagnosis UI 900) to the cause diagnosis unit 221.

Diagnosis of cause is performed by the cause diagnosis unit 221 in response to the cause diagnosis instruction. Diagnosis of cause is as follows, for example.
Metadata in the failure knowledge information 211 (metadata of the failure knowledge network 350) includes a relation value for each pair of a failure mode and a check item.
The cause diagnosis unit 221 calculates an influence degree for each pair (pair of a failure mode and a check item) represented by the failure knowledge network 350 or calculates occurrence probability of each failure mode on the basis of the failure knowledge network 350, the metadata thereof, and information (information representing relevance of each check item) from the input unit 161.

In S1305, the input unit 161 receives the input information 212 including diagnostic result information (the occurrence probability table 510 and the influence degree table 520 in the present embodiment) of cause diagnosis performed by the cause diagnosis unit 221 in response to the cause diagnosis instruction from the cause diagnosis unit 221 and stores the input information 212 in the storage apparatus 52. The input unit 161 notifies the control unit 162 of storage of the input information 212.

In S1306, the control unit 162 generates the visualization information 213 on the basis of the input information 212. Specifically, the control unit 162 converts the node coupling table 310 in the failure knowledge network 350 into the FT node coupling table 600, for example. In this conversion, relationship A (that is, generated event←functional failure), which is a relationship between a generated event node and a functional failure mode, and relationship B (that is, functional failure←failure mode), which is a relationship between a functional failure mode and a failure mode node are reversed. That is, a relationship of “generated event→functional failure” (reversal result of relationship A) and a relationship of “functional failure→failure mode” (reversal result of relationship B) are obtained. Relationship C of “failure mode→check item” is maintained (relationships A and B are examples of a first relationship, and relationship C is an example of a second relationship). Accordingly, a relationship of generated event→functional failure→failure mode→check item is formed (that is, a relationship in which two or more different types of elements are obtained as results caused by one element is eliminated, and a relationship in which one type of element is obtained as a result caused by one element is constructed), and thus an FT having a tree structure can be constructed. Further, the control unit 162 sets a layer (for example, a layer with a name represented by node_type 302) in the FT on the basis of the node table 300 (for example, node_type 302 for each node) of the failure knowledge network 350. That is, the control unit 162 converts the node table 300 into the FT node table 610 and the layer table 620. In addition, the control unit 162 extracts an occurrence probability (result 513) from each entry for which state 512 is “Y” in the occurrence probability table 510 and generates the FT occurrence probability table 630 on the basis of the extracted occurrence probability. Although layers and the names thereof can be identified on the basis of a node ID configuration (event ID_part ID_function failure ID_failure mode ID_check item ID) and the node table 300, and the FT node table 610 and the layer table 620 can be generated in the present embodiment, a table in which layers and the names thereof have been recorded may be prepared in advance (for example, prepared in the failure knowledge network 350).

In S1307, the control unit 162 determines a drawing position of a node and a highlighting target in the FT. Specifically, the control unit 162 determines a position of a band-shaped area corresponding to a layer to which a corresponding element belongs (a layer identified on the basis of the FT node table 610 and the layer table 620) as a drawing position of a node corresponding to the element for each of the plurality of elements, for example. Further, the control unit 162 determines a highlighting target as follows, for example. An occurrence probability, an influence degree, and a relevance are identified from the FT occurrence probability table 630, the influence degree table 520 (or the above-mentioned FT influence degree table), and the check item table 500 (or the above-mentioned FT check item table).
The control unit 162 determines, as display target edges in the first highlighting mode (edges indicated by thick lines in the present embodiment), all edges belonging to a path from a generated event node to a node corresponding to a failure mode with the highest occurrence probability, and edges corresponding to pairs having influence degrees that satisfy predetermined conditions among edges coupling nodes corresponding to the failure mode with the highest occurrence probability to nodes corresponding to check items associated with the failure mode.
The control unit 162 determines, as highlighting target nodes, all nodes belonging to a path from a generated event node to a node corresponding to a failure mode with the highest occurrence probability.
The control unit 162 determines, as a highlighting target node, a node corresponding to a check item having a relevance of “relevant” among a plurality of nodes corresponding to a plurality of check items.

In S1308, the control unit 162 displays the diagnosis support UI 1308. The diagnosis support UI 1308 displayed here is as follows (refer to FIG. 1).
When a range in which the FT 50 is drawn is set to the xy coordinate system, in the FT 50, the x coordinate of a corresponding node 111 is determined on the basis of a layer to which the node 111 belongs for each node 111, and the y-coordinate is determined such that the node 111 does not overlap with any node or any edge.
A causal relationship is cause→result from left (−x direction) to right (+x direction). Therefore, the order is generated event→functional failure→failure mode→check item from left to right. Although a generated event is a result and a functional failure is the cause, and the functional failure is a result and a failure mode is the cause in the failure knowledge network 350, the relationship is determined in S1306, and thus generated event→functional failure→failure mode→check items is realized.
The edges determined as display targets in the first highlighting mode in S1307 are highlighted in the first highlighting mode (that is, the edges are indicated by thick lines).
The nodes determined as highlighting targets in 51307 are highlighted. Among those nodes, a node corresponding to the failure mode with the highest occurrence probability has the highest degree of emphasis of display.
In the influence degree UI 912, an influence degree list is displayed on the basis of the influence degree table 520 in the input information 212.
In the correction history UI 913, a correction list is displayed on the basis of the FT correction history table 800, the node correction history table 810, and the edge correction history table 820 in the management information 214.

The control unit 162 can receive correction of the configuration of the FT 50 (and correction of a certainty factor and a relevance) via the tree UI 100 of the diagnosis support UI 910.

Therefore, when the management information 214 that is information representing the model of equipment and details of correction for each correction of display of the tree UI 100 includes details of correction of the same model as the model of the equipment 201, the control unit 162 presents the details of correction or a node or an edge corresponding to the details of correction to the tree UI 100 or the correction history UI 913 (an example of a UI different from the tree UI) in step 51308. Specifically, the control unit 162 performs at least one of the following, for example. Accordingly, the SME can easily estimate what kind of correction is desirable for the tree UI 100.
If the management information 214 includes details of correction including a node having the same model, part, and failure mode (or an edge connected to the node having the same model, part, and failure mode) as those of a node selected in the FT 50 (or an edge), the control unit 162 displays the details of correction in the tree UI 100 or the correction history UI 913.
When details of correction of the same model as the model of the equipment 201 (details of node correction or details of edge correction) have been selected from the correction list displayed on the correction history UI 913, if there is a node or an edge corresponding to the details of correction in the FT 50, the control unit 162 highlights the node or the edge.

When the control unit 162 receives an operation of correcting the FT configuration, a certainty factor, or a relevance via the tree UI 100 (S1309: YES), the control unit 162 performs 51310. That is, in 51310, the control unit 162 changes display of the tree UI 100 (or other related portions as necessary) according to the operation and records the name of the model of the equipment 201 and details of correction in at least one of the tables 700, 750, 800, 810 and 820 in the management information 214. That is, display of the tree UI 100 is updated according to correction, and the management information 214 is updated according to correction. The control unit 162 may update at least a part of the failure knowledge information 211 according to correction of the FT configuration, certainty factor, or relevance. After 51310, processing returns to 51309. If correction is not performed (for example, if a termination operation is performed) (S1309: NO), processing ends.

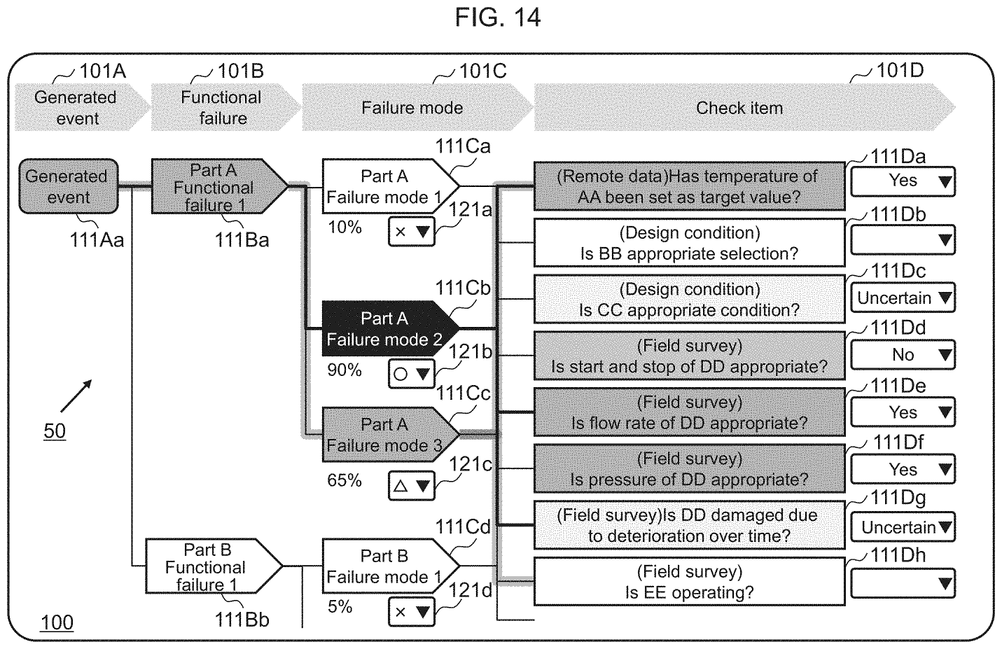

When the SME designates another failure mode node 111Cc (an example of any one node) in the FT 50 (refer to FIG. 1) including edges (edges indicated by thick lines) displayed in the first highlighting mode, the control unit 162 identifies all edges directly or indirectly coupled to the failure mode node 111Cc on the basis of the FT node coupling table 600, and displays the identified all edges directly or indirectly coupled to the failure mode node 111Cc in the second highlighting mode while maintaining display of the edges in the first highlighting mode, as shown in FIG. 14.

In the present embodiment, at least a part of the rules of the first to third types disclosed in Patent Literature 1 may be applied to the display rules of the nodes 111 and edges in the FT 50. For example, line segment overlapping in which some of line segments from one or more nodes 111 to two or more edges coupled to each of different one or more nodes 111 overlap may be permitted. Therefore, some of a plurality of edges coupling a plurality of parent nodes to a plurality of child nodes overlap, and thus it is difficult for an SME (an example of a user) to distinguish a coupling relationship between the nodes.

Therefore, by displaying the designated node 111Cc and all edges directly or indirectly coupled to the node 111Cc in the second highlighting mode (thicker than the line thickness in the first highlighting mode and in a translucent light color), as shown in FIG. 14, the SME easily ascertains the coupling relationship between the nodes.

According to FIG. 14, although the designated node is the failure mode node 111Cc, a designated node and all edges directly or indirectly coupled to the node are highlighted in the second highlighting mode regardless of which node is designated. For example, when the failure mode node 111Cb of the failure mode with the highest occurrence probability is designated, the node 111Cb and all edges directly or indirectly coupled to the node 111Cb are displayed in the second highlighting mode. When an edge displayed in the first highlighting mode is a display target in the second highlighting mode, both the first highlighting mode and the second highlighting mode are applied to display of the edge. That is, the edge is displayed in such a manner that a thick line and a translucent line in a light color overlap.

S1310 in FIG. 13 includes processing of correcting the FT configuration. Correction of the FT configuration includes at least one of node addition, edge addition, node correction, edge correction, node deletion, and edge deletion. In this manner, the control unit 162 receives correction of the configuration of the FT 50 through the tree UI 100. Therefore, it is expected that the SME can perform an accurate diagnosis on the basis of results of diagnosis of cause performed by the cause diagnosis unit 221.

Specific examples of FT configuration correction are as follows.

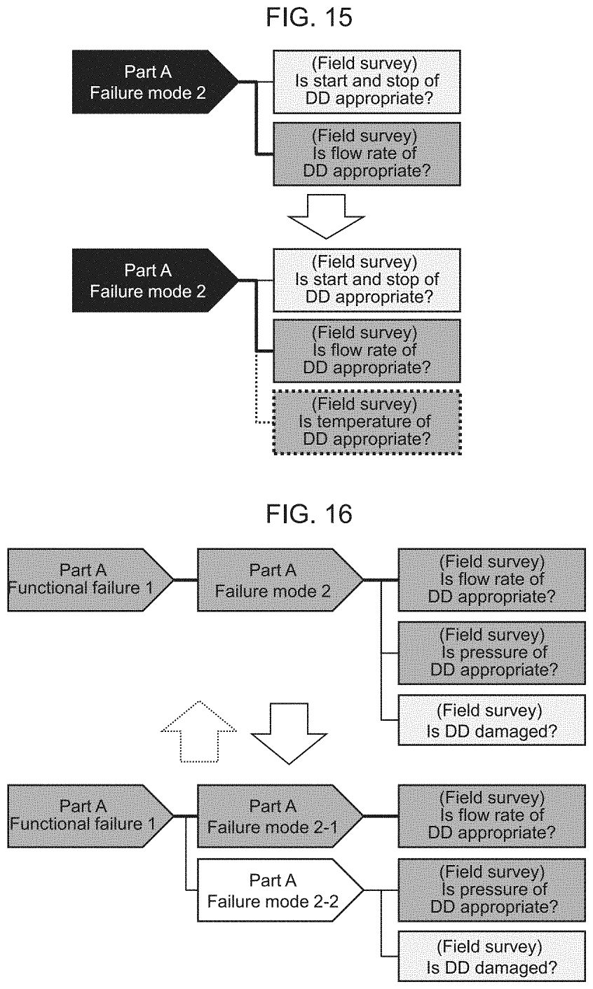

FIG. 15 shows a first specific example of FT configuration correction.

The first specific example of FT configuration correction is addition of a node. When the control unit 162 receives an operation of adding a node, the control unit 162 receives designation of a layer to which the node to be added belongs. If there is no layer to which the node to be added belongs, the control unit 162 receives an operation of adding a layer and adds the layer in response to the operation.

The control unit 162 sets a node ID of the added node as a node ID such that it is unique from the ID of a node that is a parent node of the added node and the node ID of a child node of the parent node.

As shown in FIG. 15, when the added node is a check item node, a check item corresponding to the check item node can be regarded as a “check item that has a large influence on a failure mode corresponding to the parent node and makes it easier to isolate a failure by being preferentially checked.”

Therefore, the control unit 162 highlights at least one of the newly added check item node and the edge connecting the added check item node and the parent node (failure mode node) of the check item node.

FIG. 16 shows a second specific example of FT configuration correction.

It is possible to divide a node. For example, if correction of the FT 50 configuration is to divide a failure mode node, which is a parent node of two or more check item nodes, into two or more failure mode nodes, as indicated by an arrow figure in a solid line, the control unit 162 sets, for each of the two or more check item nodes, the parent node of the corresponding check item node as one of the two or more failure mode nodes, for example, in response to an operation from the SME. Accordingly, items that need to be checked are limited, and it becomes easier for the SME to isolate a failure.

Further, node integration is also possible, as indicated by an arrow figure in a broken line. For example, the control unit 162 sets two or more failure mode nodes as one failure mode node and sets a child node (check item node) of each of the two or more failure modes as a child node of the one failure mode node.

Although one embodiment has been described above, this is an example for describing the present invention, and the scope of the present invention is not limited to this embodiment. The present invention can also be implemented in various other forms.

What is claimed is:

1. A diagnostic result visualization system comprising:
an input unit configured to receive input information including diagnosis result information representing results of diagnosis of a cause of a generated event that is an event that has occurred or may occur with respect to equipment; and
a control unit configured to display a tree user interface (UI) that is a UI having a fault tree of the generated event on the basis of the input information, wherein
the input information includes a failure knowledge network that is information representing a causal relationship between a plurality of elements, each of which is a cause or a result,
the plurality of elements include the generated event, one or more failure causes that may be a cause of the event, and a plurality of check items associated with the one or more failure causes,
the input information includes information representing, for each of the plurality of elements, a layer to which the element belongs,
the diagnosis result information includes an occurrence probability that is a value indicating, for each of the one or more failure causes, a likelihood that the failure cause is relevant and is a value calculated in the diagnosis of cause,
the fault tree is a tree having a plurality of edges coupling nodes and a plurality of nodes corresponding respectively to the plurality of elements, and
the control unit is configured to,
for each of the plurality of elements, determine a drawing position of a node corresponding to the element on the basis of a layer to which the element belongs, and
determine, as display target edges in a first highlighting mode, all edges belonging to a path from a node corresponding to the generated event to a node corresponding to a failure cause having an occurrence probability that satisfies predetermined probability conditions, and all or some of edges coupling the node corresponding to the failure cause having an occurrence probability that satisfies the predetermined probability conditions to nodes corresponding to check items associated with the failure cause.

2. The diagnostic result visualization system according to claim 1, wherein
the diagnosis result information includes information representing an influence degree that is a degree to which a check item affects a failure cause and is a value that varies depending on whether or not the check item is relevant, for each pair of a failure cause and a check item associated with the failure cause, and
all or some of the edges are edges having influence degrees satisfying predetermined influence degree conditions.

3. The diagnostic result visualization system according to claim 1, wherein
when a user designates any node of the fault tree including edges displayed in the first highlighting mode, the control unit displays all edges directly or indirectly coupled to a designated node, which is the designated node, in a second highlighting mode while maintaining display of the edges in the first highlighting mode, and
an edge directly coupled to the designated node is an edge having the designated node as a coupling source or a coupling destination, and
an edge indirectly coupled to the designated node is an edge coupled to the designated node via one or more nodes above the designated node or one or more nodes below the designated node.

4. The diagnostic result visualization system according to claim 1, wherein the control unit determines, as highlighting target nodes, all nodes belonging to the path from the node corresponding to the generated event to the node corresponding to the failure cause having an occurrence probability that satisfies the predetermined probability conditions.

5. The diagnostic result visualization system according to claim 4, wherein the input information includes information indicating, for each of the plurality of check items, whether or not the check item is relevant,
wherein the control unit determines, as a highlighting target node, a node corresponding to the check item among a plurality of nodes corresponding respectively to the plurality of check items.

6. The diagnostic result visualization system according to claim 1, wherein
in the failure knowledge network, a relationship between an event and a failure cause is a first relationship in which the event is a result and the failure cause is a cause, and a relationship between a check item and a failure cause is a second relationship in which the check item is a result and the failure cause is a cause,
the control unit generates a fault tree on the basis of a failure knowledge network in which the first relationship is reversed,
in the fault tree, the node corresponding to the generated event is a root node, and nodes corresponding to check items are leaf nodes as child nodes having a node corresponding to a failure cause as a parent node.

7. The diagnostic result visualization system according to claim 6, wherein, in the tree UI,
a plurality of band-shaped areas corresponding respectively to a plurality of layers are arranged in a first direction that is a horizontal direction or a perpendicular direction,
each of the plurality of band-shaped areas is an area in which a length in a second direction orthogonal to the first direction is greater than a length in the first direction, and
for each of the plurality of layers, a drawing position of each of one or more nodes corresponding respectively to one or more elements belonging to the layer is a position of a band-shaped area corresponding to the layer.

8. The diagnostic result visualization system according to claim 1, wherein the control unit receives correction of a configuration of the fault tree through the tree UI.

9. The diagnostic result visualization system according to claim 8, wherein, when the correction of the configuration of the fault tree is to newly add a node corresponding to a check item to a node corresponding to a failure cause, the control unit highlights at least one of the newly added node and an edge connecting the added node and the node corresponding to the failure cause.

10. The diagnostic result visualization system according to claim 9, wherein, when the correction of the configuration of the fault tree is to divide a failure cause node, which is a parent node of two or more check item nodes, into two or more failure cause nodes, for each of the two or more check item nodes, a parent node of the check item node is any one of the two or more failure cause nodes,
the check item nodes are nodes corresponding to check items, and
the failure cause nodes are nodes corresponding to failure causes.

11. The diagnostic result visualization system according to claim 2, wherein
the tree UI has a UI part that receives an input of determination of a user, and
the UI part is at least one of the following,
(x) a UI part that receives an input of a certainty factor at which the user has determined, for each of the one or more failure causes, that the failure cause is a cause of the generated event, and
(y) a UI part that receives an input of whether or not, for each of the plurality of check items, the check is relevant.

12. The diagnostic result visualization system according to claim 1, wherein the control unit is configured to receive correction of the configuration of the tree and to add information representing a model of the equipment and details of the correction to management information that is information representing a model of equipment and details of correction for each correction of the configuration of the fault tree, and
when the management information includes details of a correction of the same model as the model of the equipment in which the generated event has occurred or may occur, the control unit presents the details of correction or a node or an edge corresponding to the details of correction to the tree UI or a UI different from the tree UI.

13. The diagnostic result visualization system according to claim 1, wherein
the control unit displays a cause diagnosis UI with respect to the generated event,
the cause diagnosis UI receives an input of whether or not each of the plurality of check items listed in the cause diagnosis UI is relevant,
the input unit receives the input information from a cause diagnosis unit that performs diagnosis of cause by transmitting information representing details of the input received by the cause diagnosis UI and the generated event to the cause diagnosis unit,
the input information includes information representing whether or not each of the plurality of check items is relevant, and
the tree UI displays whether or not the check item is relevant for each of a plurality of nodes corresponding respectively to the plurality of check items according to the input information.

14. A diagnostic result visualization method performed by a computer, the method comprising:
(A) receiving input information including diagnosis result information representing results of diagnosis of a cause of a generated event that is an event that has occurred or may occur with respect to equipment; and
(B) displaying a tree user interface (UI) that is a UI having a fault tree of the generated event on the basis of the input information, wherein
the input information includes a failure knowledge network that is information representing a causal relationship between a plurality of elements, each of which is a cause or a result,
the plurality of elements include the generated event, one or more failure causes that may be a cause of the event, and a plurality of check items associated with the one or more failure causes,
the input information includes information representing, for each of the plurality of elements, a layer to which the element belongs,
the diagnosis result information includes an occurrence probability that is a value indicating, for each of the one or more failure causes, a likelihood that the failure cause is relevant and is a value calculated in the diagnosis of cause,
the fault tree is a tree having a plurality of edges coupling nodes and a plurality of nodes corresponding respectively to the plurality of elements, and
in (B), the computer
determines, for each of the plurality of elements, a drawing position of a node corresponding to an element on the basis of a layer to which the element belongs, and
determines, as display target edges in a first highlighting mode, all edges belonging to a path from a node corresponding to the generated event to a node corresponding to a failure cause having an occurrence probability that satisfies predetermined probability conditions, and all or some of edges coupling the node corresponding to the failure cause having an occurrence probability that satisfies the predetermined probability conditions to nodes corresponding to check items associated with the failure cause.
